(19) United States
(12) Patent Application Publication
(10) Pub. No.: US 2020/0307521 A1
(43) Pub. Date: Oct. 1, 2020

(54) LOW PROFILE LIFTER FOR WINDSHIELD BLADE

(71) Applicant: James Nielsen, Houston, TX (US)

(72) Inventor: James Nielsen, Houston, TX (US)

(21) Appl. No.: 16/363,086

(22) Filed: Mar. 25, 2019

(51) Int. Cl. B60S 1/04; B65D 33/28

(52) U.S. Cl. CPC B60S 1/0491; B65D 33/28

(57) ABSTRACT

A lifter for windshield wiper blade includes a body having first and second opposite end portions. The body is horizontally elongate with a vertically low profile. The first and second end opposite portions are without any corners. The first opposite end portion releasably contacts the windshield when the body portion is positioned between a wiper arm and a windshield. The second opposite end portion releasably supports the wiper arm in a spaced apart relationship to the windshield when the first opposite end portion contacts the windshield and the body portion is positioned between the wiper arm and the windshield. The first and second end opposite portions are free from attachment to the wiper arm and the windshield, The body is supportively firm along the vertically low profile and vertically flexible along the second opposite end portion in supporting the wiper arm. The body has a positive water buoyancy.

### TECHNICAL FIELD

The present invention relates generally to windshield blades of vehicles. More particularly, the present invention relates to lifter for windshield blades for vehicles.

### BACKGROUND

Many vehicles are provided with windshield wipers to keep the window free from rainfall, insects, bird droppings, or other obstructing things that may fall against the windshield of a vehicle and obstruct the view. In an illustrative example depicting two windshield wipers shown in FIG. 1A, windshield wipers 11a, 11b typically include an arm 12a, 12b, and a windshield wiper blade 14a, 14b. The arm 12a, 12b of the windshield wiper 11a, 11b is typically attached at one end 16a, 16b to a mechanism (not shown) for rotation about the point of attachment. Typically, the attachment is to some motorized mechanism configured to rotate the arm of the windshield wiper so as to sweep back and forth across the window. The windshield wiper blade 14a, 14b, typically made from rubber, is disposed between a window 18 and the arm 12a, 12b so as to lie against the window 18. Under the influence of the arm 12a, 12b sweeping across the window, the windshield wiper blade 14a, 14b is caused to sweep across the windshield 18 and with it sweep aside the rainfall, insects, bird droppings, or other obstructing things that may fall against the windshield of a vehicle.

For the windshield wiper blade to sweep aside as much of these obstructing things as possible, it is important for there to be good surface contact between the blade and the windshield. Anywhere there is no surface contact or the surface contact is not good, the blade will not sweep aside any or sufficiently remove obstructing things lying on the window.

Extreme weather may affect the surface contact between a blade and a windshield. Extreme cold, such as may occur during cold winter, may cause the rubber of the wiper blade to stiffen due to the cold and cause the blade to crack or deform. Extreme heat, such as may occur during a hot summer, may cause the rubber to tear, warp, or otherwise deform. FIG. 1B depicts a blade 14a, 14b with a crack or tear 25a and warping 25b due to extreme cold or heat, as the case may be, A cracked or deformed blade reduces the surface contact between the blade and the window, thereby not sweeping aside or sufficiently removing the obstructing things when sweeping across the window.

To prevent blade cracking or deformation, when snow or freezing conditions are expected, some individuals may lift their wiper blades into a fully extended position away from the window. As depicted in FIG. 1C, this may create other problems such as bending 33a, 33b of the wiper arm 12a, 12b due to different levels of snowfall 19a, 19b, 19c.

There exist a number of devices for lifting the windshield blades to a position that lies between the window and the fully extended position of the arm so as to avoid the foregoing illustrative problems with convention windshield wipers. These devices are intricately designed with features to account for the physics at play between the device and the arm and windshield when the device is employed. For example, U.S. Pat. No. 9,381,891 to Petrovic teaches a wiper arm stand having a body 130 and three legs 140 (although it could have two or more legs) and a support 170 for holding the wiper arm away from the window.

U.S. Pat. No. D714,709 S to Bussard. et al. teaches a windshield wiper standoff for placement between a window and a wiper arm designed with certain structural features and a slot at the top configured to hold the wiper arm away from the window.

U.S. Pat. No. 5,873,141 A to Tackett teaches a device placed between a window arm and a window to keep the windshield wiper away from the window. Projections 18 and 66 are features that cause the device to tip over when the wiper arm is turned on and moves against the projection.

U.S. Pat. No. 5,675,861 A to Ayers teaches a device that is placed on a windshield to receive and hold a windshield blade suspended above the windshield. The device has a base with a channel 22 that receives a rotor 20 with a v-shaped channel. The windshield blade moves up the platform and into the v-shaped shaped channel to rotate the rotor to a final position whereby the windshield blade is suspended above the surface of the window thereby extending the life of the blade.

DE 102013004970 A1 to Schilder, FR 2915444 B1 to Wong, DE 3325707 A1 to Rehak, and EP 1174315 A2 to Losch teach other configurations.

There is a need for an improved lifter for wiper blades.

Unless otherwise indicated herein, the materials described in this section are not prior art to the claims in this application and are not admitted to be prior art by inclusion in this section.

### SUMMARY

A lifter for windshield wiper blade includes a body having first and second opposite end portions. The body is horizontally elongate and has a vertically low profile. The first and second end opposite portions may be without any corners. The first opposite end portion releasably contacts the windshield when the body portion is positioned between a wiper arm and a windshield. The second opposite end portion releasably supports the wiper arm in a spaced apart relationship to the windshield when the first opposite end portion contacts the windshield and the body portion is positioned between the wiper arm and the windshield. The first and second end opposite portions are free from attachment to the wiper arm and windshield. The body is supportively firm along the vertically low profile. The supportive firmness is configured to support the wiper arm in a spaced apart relationship to the windshield when the first opposite end portion contacts the windshield and the body portion is positioned between the wiper arm and the windshield. The body is vertically flexible along at least a portion of the second opposite end portion. The vertical flexibility is configured to cushion the support of the wiper arm when the first opposite end portion contacts the windshield and the body portion is positioned between the wiper arm and the windshield. The body has a water buoyance that is positive.

In another aspect, a body of a lifter for windshield wiper blade may be horizontally circular and have a vertically low profile. In another aspect, a body of a lifter for windshield wiper blade may be horizontally rectangular and have a vertically low profile.

In further aspects, the body may comprise biodegradeable material, be provided with graphics, attach to a lanyard for attachment to a windshield wiper arm, or be combined with a container or tote bag with a draw string for storage or transport. In other aspects, one or more bodies may be used to support one or more windshield wiper arms on any type of vehicle.

3

### BRIEF DESCRIPTION OF THE DRAWINGS

FIGS. 1A-1C show prior art windshield wiper blades and problems. FIGS. 1A-1C collectively hereinafter FIG. 1.

FIG. 2A shows a perspective view, FIG. 2B a front view, FIG. 2C a back view, FIG. 2D a top view, FIG. 2E a bottom view, FIG. 2F a right side view, and FIG. 2G a left side view of an illustrative embodiment of this disclosure. FIGS. 2A-2G collectively hereinafter FIG. 2.

FIGS. 3A-3C show illustrative embodiment according to this disclosure. FIGS. 3A-3C collectively hereinafter FIG. 3.

FIGS. 4A-4B show illustrative embodiment of this disclosure. FIGS. 4A and 4B collectively hereinafter FIG. 4.

FIGS. 5A-5C show illustrative embodiment of this disclosure. FIGS. 5A, 5B and 5C collectively hereinafter FIG. 5.

FIG. 6 shows illustrative embodiment provided with graphics according to this disclosure.

FIGS. 7A-7C show illustrative embodiment provided with graphics according to this disclosure. FIGS. 7A-7C collectively hereinafter FIG. 7.

FIGS. 8A-8B show illustrative embodiment of this disclosure. FIGS. 8A and 8B collectively hereinafter FIG. 8.

FIG. 9 shows illustrative embodiment of this disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

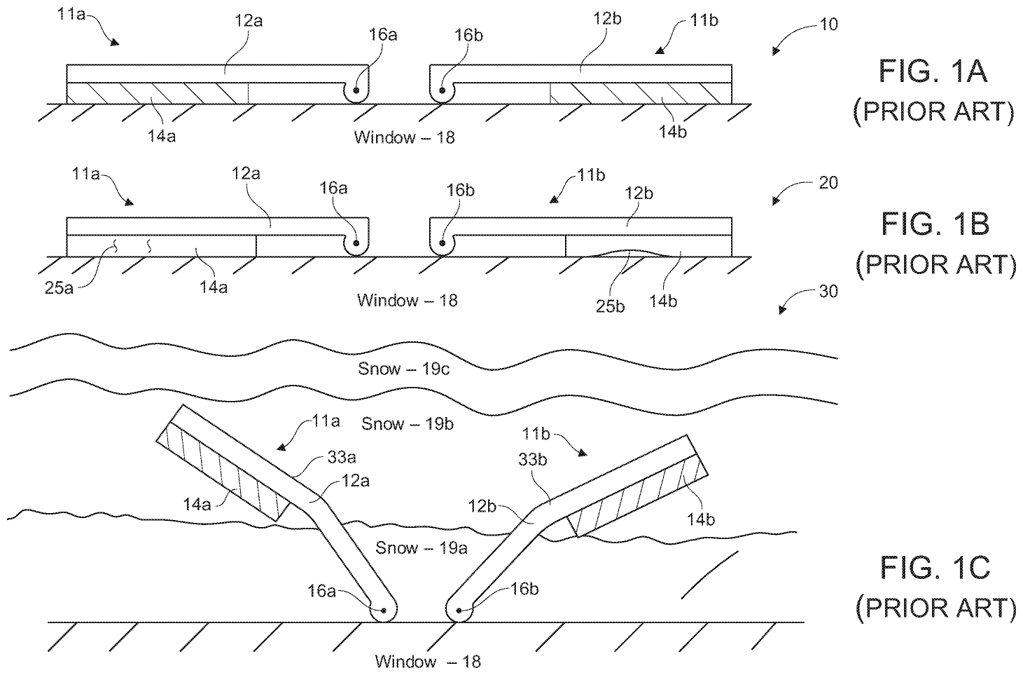

As previously described, many vehicles are provided with windshield wipers to keep the window free from rainfall, insects, bird droppings, or other obstructing things that may fall against the windshield of a vehicle and obstruct the view. In an illustrative example depicting two windshield wipers shown in FIG. 1A, windshield wipers 11a, 11b typically include an arm 12a, 12b, and a windshield wiper blade 14a, 14b. The arm 12a, 12b of the windshield wiper 11a, 11b is typically attached at one end 16a, 16b to a mechanism (not shown) for rotation about the point of attachment. Typically, the attachment is to some motorized mechanism configured to rotate the arm of the windshield wiper so as to sweep back and forth across the window. The windshield wiper blade 14a, 14b, typically made from rubber, is disposed between a window 18 and the arm 12a, 12b so as to lie against the window 18. Under the influence of the arm 12a, 12b sweeping across the window, the windshield wiper blade 14a, 14b is caused to sweep across the windshield 18 and with it sweep aside the rainfall, insects, bird droppings, or other obstructing things that may fall against the windshield of a vehicle.

This disclosure addresses a need for an improved lifter for wiper blades including for extending the life of wiper blades. Broadly speaking, a lifter for windshield wiper blade of this disclosure includes a body having first and second opposite end portions. The body is horizontally elongate with a vertically low profile. The first and second end opposite portions are without any corners. The first opposite end portion releasably contacts the windshield when the body portion is positioned between a wiper arm and a windshield. The second opposite end portion releasably supports the wiper arm in a spaced apart relationship to the windshield when the first opposite end portion contacts the windshield and the body portion is positioned between the wiper arm and the windshield. The first and second end opposite portions are free from attachment to the wiper arm and the windshield, The body is supportively firm along the vertically low profile and vertically flexible along the second opposite end portion in supporting the wiper arm. The body has a positive water buoyancy.

The lifter of this disclosure extends the life of wiper blades with a low profile and simple, easy to use, user friendly, cost effective, mechano-dynamically modeled, and economically friendly lifter for windshield wiper blade. The disclosed lifter is aesthetically pleasing and enhances surface area for designer graphics and/or personalization. The lifter of this disclosure is biodegradable, ecologically friendly, easily transportable, and with a buoyancy of under 1 floats on water.

The vehicle with which the lifter of this disclosure may be used may be any vehicle including vehicles selected from the group consisting of motor vehicles, including cars, trucks, buses, motorcycles including mopeds and scooters, railed vehicles, including trains and trams, watercraft including ships and boats, amphibious vehicles including screw-propelled vehicle, hovercraft, aircraft including airplanes and helicopters, spacecraft, and wagons, bicycles, and carts including manual push or pull carts and mobile carts, including animal drawn carts and golf carts.

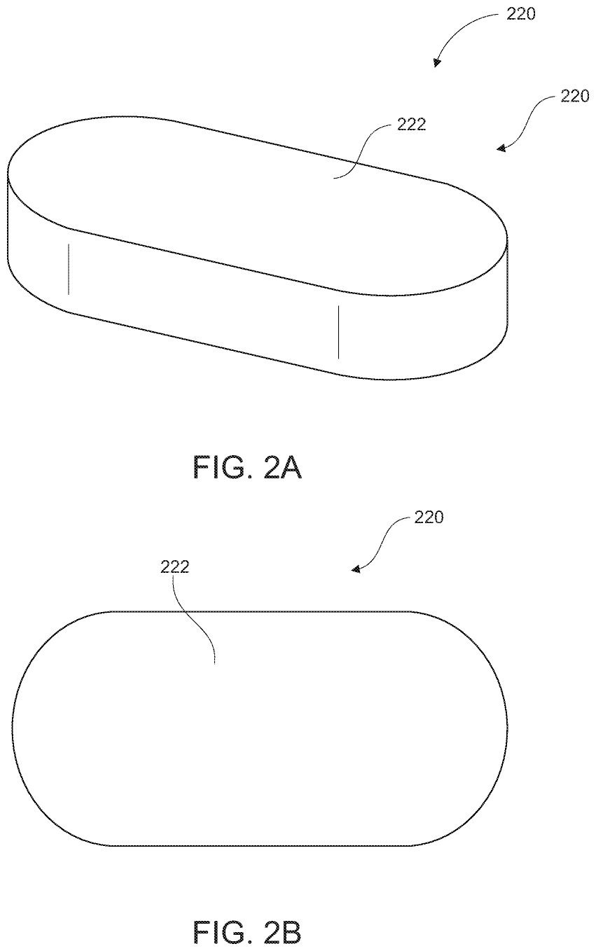

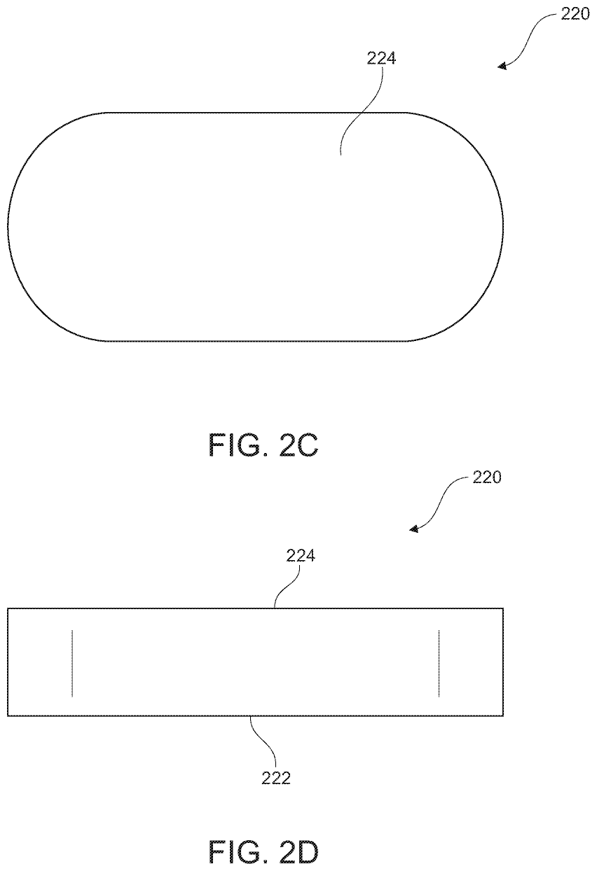

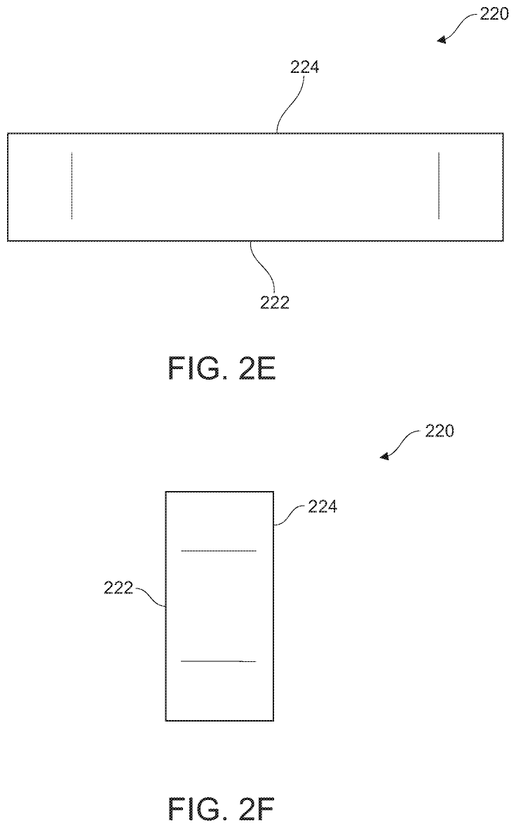

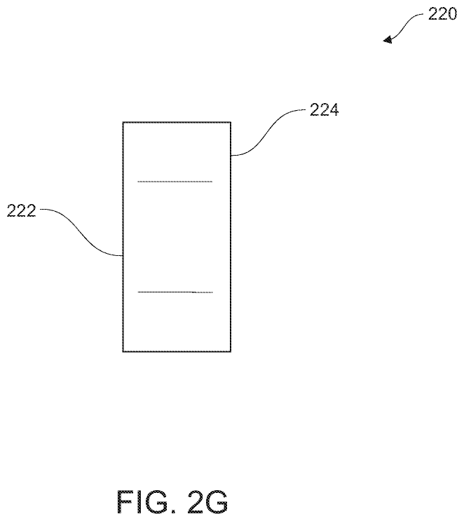

Turning now to the figures illustrating the lifter of this disclosure, FIG. 2A shows a perspective view, FIG. 2B a front view, FIG. 2C a back view, FIG. 2D a top view, FIG. 2E a bottom view, FIG. 2F a right side view, and FIG. 2G a left side view of an illustrative embodiment of this disclosure. FIGS. 2A-2G collectively hereinafter FIG. 2. As shown in FIGS. 2A-2G, a lifter 200 for windshield wiper blade of this disclosure includes a body 220 having first and second opposite end portions, depicted as elements 222 and 224, respectively in FIG. 2.

As illustrated in FIGS. 2A-2C, the body 220 is horizontally elongate with a vertically low profile. By “horizontally elongate” is meant that the length of the body 220 is longer than the width of the body 220. By “vertically low profile” is meant that the height of the body 220 does not elevate the wiper arm more than about three inches when placed between the window and the window arm.

In one illustrative embodiment, the horizontal elongateness of the body measures about 4 inches in a lengthwise direction of the horizontal elongateness and about 3 inches in a widthwise direction of the horizontal elongateness, and the vertically low profile of the body measures about three inches.

The body 220 is illustratively made from biodegradable materials. By “biodegradable” is meant capable of being broken down (decomposed) rapidly by the action of microorganisms. Biodegradable materials for use with this disclosure may include biodegradable sponge, cotton, wool, wood, manufactured products based on natural materials (such as paper, and vegetable-oil based soaps), cork, bamboo, bioplastics, fibreboard that uses potato starch, and so on.

Preferably the body 220 is made from a biodegradeable foam. Alternatively, body 220 may be made from a biodegradeable hemp plastic. The selection of biodegradable material for use for the body 220 is a matter of design choice.

In an alternatively embodiment, the body 220 may be made from a material that is not biodegradeable. For instance, foamed plastic, rubber, nylon, and any other material that meets the design requirements of this disclosure but that are considered not biodegradeable may be used.

Illustratively, the first and second end opposite portions are without any corners. The absence of corners on the body 220 enhances safety in the use of the lifter, for example, since it removes all corners which may be poked into the eye or used in other ways which may not be safe to the user.

The body 220 may be supportively firm along the vertically low profile. The supportive firmness configures the body 220 to support the weight of the wiper arm in a spaced apart relationship to the windshield when the first opposite end portion contacts the windshield and the body portion is positioned between the wiper arm and the windshield.

The body 220 may be vertically flexible along at least a portion of the second opposite end portion. Alternatively, the body 220 may be vertically flexible along a substantial portion or all of the second opposite end. The vertical flexibility configures the body 220 to cushion the support of the wiper arm when the first opposite end portion contacts the windshield and the body portion is positioned between the wiper arm and the windshield. The vertical flexibility provides soft cushioning for the wiper arm supported thereon while keeping the windshield wiper blade away from the windshield. The amount of vertical flexibility to keep the windshield wiper blade away from the windshield is a matter of design choice.

In use, the first opposite end portion 224 releasably contacts a windshield when the body portion 220 is positioned between a wiper arm and a windshield. The second opposite end portion 222 releasably supports the wiper arm in a spaced apart relationship to the windshield when the first opposite end portion contacts the windshield and the body portion is positioned between the wiper arm and the windshield.

In the foregoing embodiment, the first and second end opposite portions 222, 224, respectively, are free from attachment to the wiper arm and windshield. This allows the body 220 to be easily inserted between the wiper arm and windshield for use and easily removed from between the wiper arm and windshield when not in use.

In the foregoing embodiment, the body 220 may be placed between a wiper arm and windshield when a vehicle is not being used. The body 220 of the lifter 200 advantageously lifts the wiper arm away from the window thereby lifting the wiper blades away from the window so as protect the wiper blades from cracking, stretching, warping, or developing other defects.

In another embodiment, the body 220 is configured to have a positive water buoyance. By “buoyancy” is meant the ability of the lifter of this disclosure to float on water. An object that floats in water is said to be positively buoyant. An object that sinks is negatively buoyant. To determine an object's buoyancy, both its mass and volume must be taken into consideration. The relationship between object's volume and mass is called its density. Density is defined as the mass of an object per unit volume. Mathematically, this relationship is described using the following equation density=mass/volume. An object will float or sink depends on its own density and the density of the liquid it is placed in. In the case of water, an object with a density less than 1 g/cm3 will float. In accordance with this disclosure, the lifter of this disclosure is configured to have a density less than 1 g/cm3.

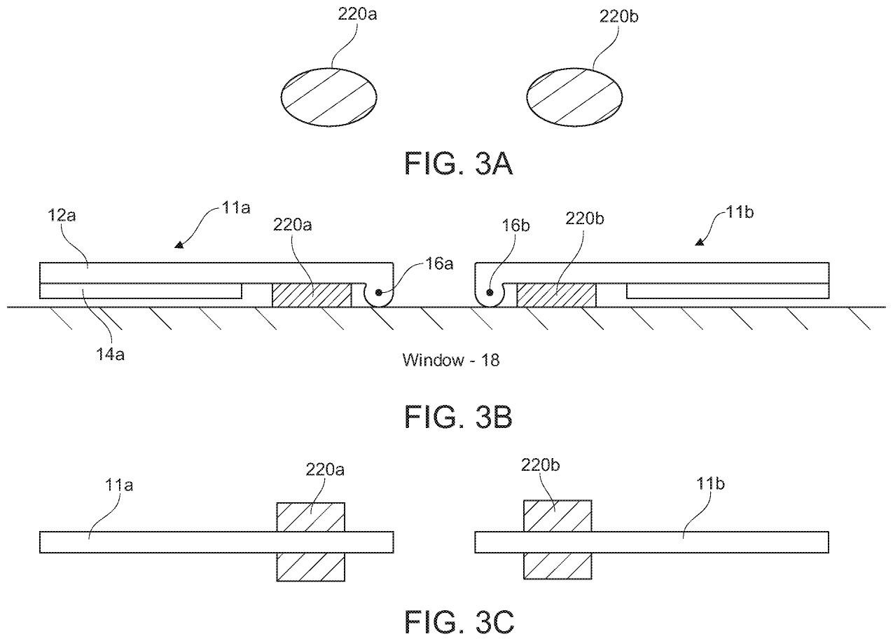

FIG. 3 illustrates another embodiment of this disclosure. In this embodiment, a first body 220a and a second body 220b form a pair of lifters for use with a pair of wipers 11a, 11b. Each of the pair of lifters is configured for supporting each of a pair of wiper arms 12a, 12b in a spaced apart relationship to the windshield 18.

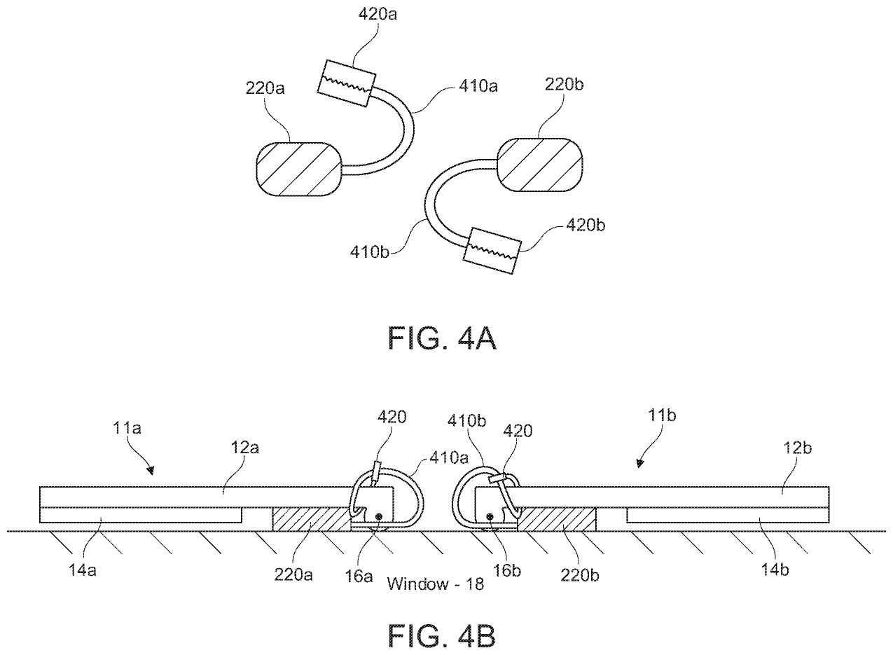

In another illustrative embodiment depicted in FIG. 4, a pair of lifters illustrated as bodies 220a, 22b for windshield wiper blade further comprises a lanyard 410a, 410b, respectively. Each lanyard is illustratively attached at a first end to an attachment mechanism 410a, 410b, respectively. Each lanyard is configured for wrapping around the wiper arm 11a, 11b, respectively. The attachment mechanism 420a, 420b is configured to attach the first end of the lanyard to another part of the lanyard after the lanyard has been wrapped around the wiper arm as shown in FIG. 4.

The lanyard may be any rope or cord and may be made from Nylon, Cotton, Polyester, twill, nylon, polyester, and so on. The attachment mechanism may be an alligator clip with jaws that grab and hold the clip to the part of the lanyard after wrapping of the lanyard around the wiper arm as shown in FIG. 4. Alternatively, the attachment mechanism may be a releasable clasp that may be opened, placed about the part of the lanyard after wrapping, and then released to close and hold the first end of the lanyard to the part of the lanyard after wrapping around the wiper arm. In another embodiment, the attachment mechanism may be a connector material attached to the first end of the lanyard having a Velcro® hook and loop fastener which may secure the connector material to the part of the lanyard after wrapping around the wiper arm. Any mechanism for attaching the first part of the lanyard to the part of the lanyard after wrapping around the wiper arm may be used, depending upon design choice.

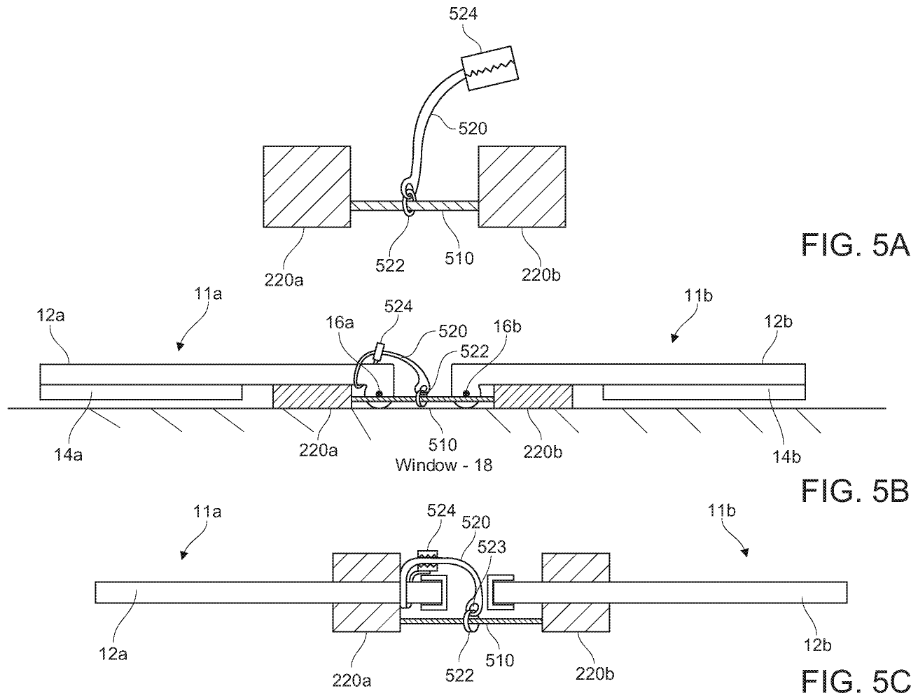

In another illustrative embodiment depicted in FIG. 5, a pair of lifters illustrated as bodies 220a, 220b for windshield wiper blade further comprises a first lanyard 510 attached at a first end to the body 220a and at a second end to the body 220b of the two lifters together forming the pair of lifters. A second lanyard 520 has a sliding mechanism 522 at one end and an attachment mechanism 524 at a second end. The sliding mechanism 522 of the second lanyard is configured to slide along the first lanyard 510. The second end of the second lanyard 520 is configured for wrapping around the wiper arm 12a. An attachment mechanism 524 is configured to attach the first end of the lanyard 520 to a part of the lanyard 520 after the lanyard 520 has been wrapped around the wiper arm 11a as shown in FIG. 5.

The lanyards may be rope or cord made from the materials previously described. The attachment mechanism may be an alligator clip or any of the other attachment mechanisms previously explained. The sliding mechanism 522 may be a ring made from plastic or other material to which is coupled a loop 523 located at one end of the lanyard 520. Alternatively, the lanyard 510 may be threaded through the loop 523 located at the one end of the lanyard 520 to serve as the sliding mechanism; obviating the need for the separate ring.

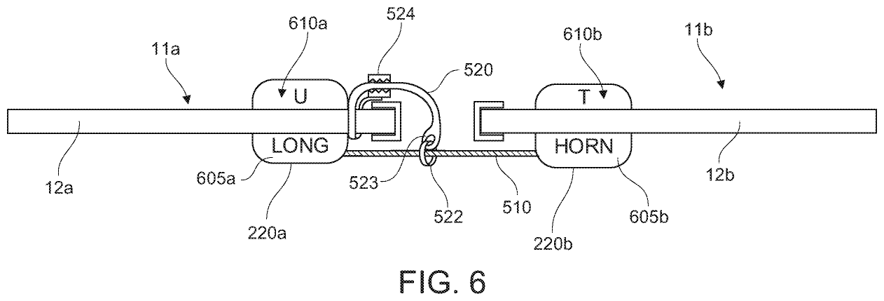

FIG. 6 shows the embodiment of FIG. 5 with a second opposite end portion 605a, 605b provided with graphics 610a, 610b. Any graphics may be provided including words, marks, designs, pictures, or any visually perceptible artifact. The graphics on the second opposite end portion may be selected from the group consisting of silk screened graphics and thermal printed graphics. These or other graphics are a matter of design choice. Graphics allow the lifter of this disclosure to be personalized to the preference of the user.

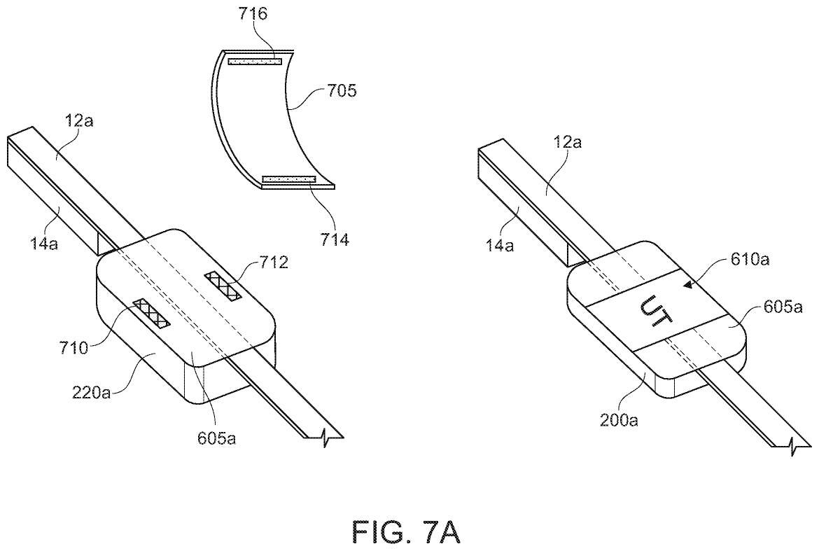

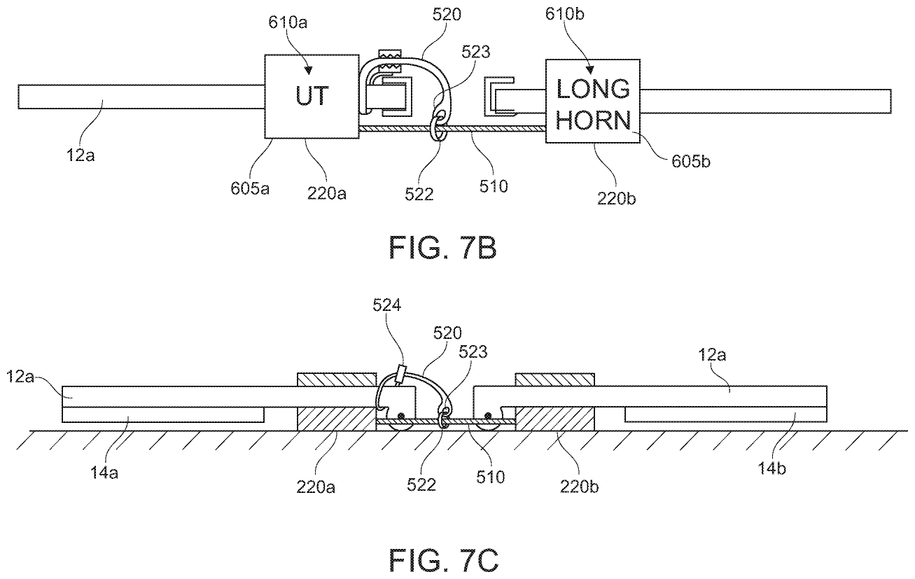

FIG. 7 shows the embodiment of FIG. 6 further comprising an attachment panel 705 with Velcro connects 716, 714 for attachment to Velcro connects 710, 712 on second opposite end portion 605a of body 220a. The connection of Velcro connects 716, 714 to 710, 712 are as depicted in FIG. 7A. The same may apply to body 220b. Graphics 610a appear on the second opposite end portion as an application to the attachment panel 705. The graphics on the second opposite end portion may be selected from the group consisting of silk screened graphics and thermal printed graphics. These or other graphics are a matter of design choice. Graphics allow the lifter of this disclosure to be personalized to the preference of the user.

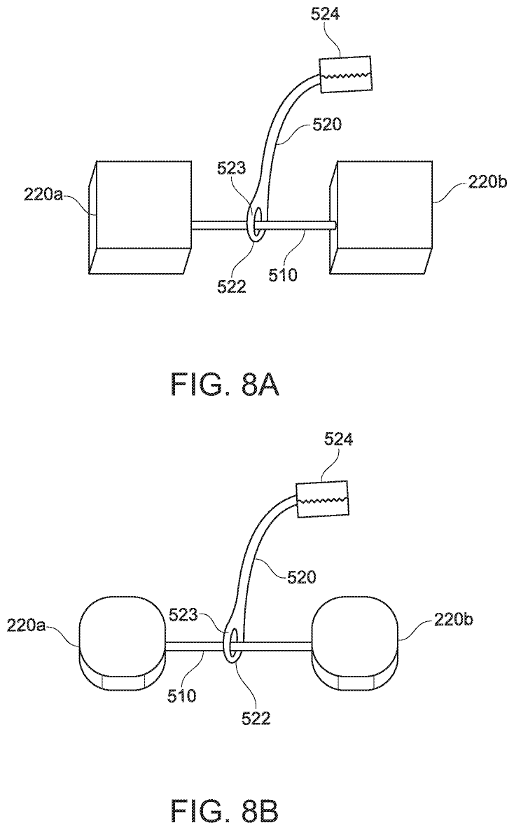

FIG. 8 shows the embodiment of FIG. 5 wherein bodies 220a, 220 comprising the lifter pair may be horizontally rectangular and have a vertically low profile as depicted in FIG. 8A or horizontally circular and have a vertically low profile as depicted in FIG. 8B.

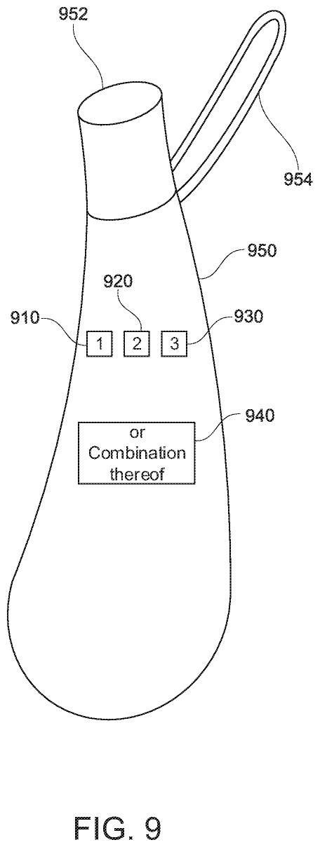

FIG. 9 depicts a lifter 910, 920, 930, or combination thereof 940 for windshield wiper in combination with a container 950 configured for storing the lifters. Illustratively, the container may be configured for storing the lifters is a drawstring tote bag having an opening 952 and pull string 954 for closing the opening. Alternatively, any container or bag for storing and/or transporting the lifters may be used.

While illustrative examples of lifter dimensions have been disclosed, it will be appreciated that the dimensions are a matter of design choice subject to the restrictions imposed by this disclosure. For example, the vertical low profile of this disclosure is restricted to less than about three inches in height as previously explained. The length of the lifter is a matter of design choice limited by the arm of the blade between the point of attachment and the windshield blade under which the lifters are placed. The width of the lifter is a matter of design choice limited by the body of the vehicle.

Any number of lifters may be used with a windshield blade, limited only by length of the arm of the blade between the point of attachment and the windshield blade under which the lifters are placed. For example, two lifters may be spaced apart from each other under the wiper arm. The vertically flexibility of the body may allow the lifter closest to the blade to be more flexed than the other lifter. Such an arrangement may help distribute the weight of the wiper arm across two or more lifters. The number of lifters is limited only by the length of the arm of the blade between the attachment point and the windshield arm.

There is thus disclosed a lifter for windshield wiper blade includes a body having first and second opposite end portions. The body is horizontally elongate with a vertically low profile. The first and second end opposite portions are without any corners. The first opposite end portion releasably contacts the windshield when the body portion is positioned between a wiper arm and a windshield. The second opposite end portion releasably supports the wiper arm in a spaced apart relationship to the windshield when the first opposite end portion contacts the windshield and the body portion is positioned between the wiper arm and the windshield. The first and second end opposite portions are free from attachment to the wiper arm and the windshield, The body is supportively firm along the vertically low profile and vertically flexible along the second opposite end portion in supporting the wiper arm. The body has a positive water buoyancy.

In one aspect, there is disclosed a lifter for windshield wiper blade includes a body having first and second opposite end portions. The body is horizontally elongate and has a vertically low profile. The first and second end opposite portions are without any corners. The first opposite end portion releasably contact the windshield when the body portion is positioned between a wiper arm and a windshield. The second opposite end portion releasably supports the wiper arm in a spaced apart relationship to the windshield when the first opposite end portion contacts the windshield and the body portion is positioned between the wiper arm and the windshield. The first and second end opposite portions are free from attachment to the wiper arm and windshield. The body is supportively firm along the vertically low profile. The supportive firmness is configured to support the wiper arm in a spaced apart relationship to the windshield when the first opposite end portion contacts the windshield and the body portion is positioned between the wiper arm and the windshield. The body is vertically flexible along at least a portion of the second opposite end portion. The vertical flexibility is configured to cushion the support of the wiper arm when the first opposite end portion contacts the windshield and the body portion is positioned between the wiper arm and the windshield. The body has a water buoyance that is positive.

In another aspect, the body is vertically flexible along a substantial portion of the second opposite end.

In another aspect, the horizontal elongateness of the body measures about 4 inches in a lengthwise direction of the horizontal elongateness and about 3 inches in a widthwise direction of the horizontal elongateness, and the vertically low profile of the body measures about three inches.

In another aspect, the body comprises a biodegradeable material.

In another aspect, the lifter for windshield wiper blade further comprises a second lifter for windshield wiper blade in accord with the explanation above. The two lifters together form a pair of lifters. Each of the pair of lifters is configured for supporting each of a pair of wiper arms in a spaced apart relationship to the windshield.

In another aspect, the second opposite end portion is provided with graphics.

In another aspect, the graphics on the second opposite end portion are selected from the group consisting of silk screened graphics and thermal printed graphics.

In another aspect, the lifter for windshield wiper blade further comprises a lanyard attached at a first end to an attachment mechanism. The lanyard is configured for wrapping around the wiper arm. The attachment mechanism is configured to attach the first end of the lanyard to the lanyard after the lanyard has been wrapped around the wiper arm.

In another aspect, the lifter for windshield wiper blade further comprises a first lanyard attached at a first end to a first and at a second end to a second of the two lifters together forming the pair of lifters. A second lanyard has a sliding mechanism at one end and an attachment mechanism at a second end. The sliding mechanism of the second lanyard is configured to slide along the first lanyard and the second lanyard is configured for wrapping around the wiper arm. The attachment mechanism is configured to attach the first end of the lanyard to the lanyard after the lanyard has been wrapped around the wiper arm.

In another aspect, the lifter for windshield wiper blade further comprises an attachment panel attached to the second opposite end portion. The graphics on the second opposite end portion are applied to the attachment panel.

In another aspect, the lifter for windshield wiper is combined with a container configured for storing the lifters. In another aspect, the container configured for storing the lifter is a tote bag. In another aspect the tote bag has a drawstring.

In another aspect, the body comprises biodegradable material.

In another aspect, body of this disclosure is used with a vehicle selected from the group consisting of motor vehicles, including cars, trucks, buses, motorcycles including mopeds and scooters, railed vehicles, including trains and trams, watercraft including ships and boats, amphibious vehicles including screw-propelled vehicle, hovercraft, aircraft including airplanes and helicopters, spacecraft, and wagons, bicycles, and carts including manual push or pull carts and mobile carts, including animal drawn carts and golf carts.

In another aspect, a lifter for windshield wiper blade comprises a body having first and second opposite end portions. The body is horizontally circular and has a vertically low profile. The first and second end opposite portions are without any corners. The first opposite end portion releasably contacts the windshield when the body portion is positioned between a wiper arm and a windshield. The second opposite end portion releasably supports the wiper arm in a spaced apart relationship to the windshield when the first opposite end portion contacts the windshield and the body portion is positioned between the wiper arm and the windshield. The first and second end opposite portions are free from attachment to the wiper arm and windshield. The body is supportively firm along the vertically low profile. The supportive firmness is configured to support the wiper arm in a spaced apart relationship to the windshield when the first opposite end portion contacts the windshield and the body portion is positioned between the wiper arm and the windshield. The body is vertically flexible along at least a portion of the second opposite end portion. The vertical flexibility is configured to cushion the support of the wiper arm when the first opposite end portion contacts the windshield and the body portion is positioned between the wiper arm and the windshield. The body has a water buoyance that is positive.

In another aspect, the horizontal circleness of the body measures about ½ inches in the radius of the circle defined by the horizontal circleness, and the vertically low profile of the body measures about 1 inch.

In another aspect, the horizontal circleness of the body measures about ¾ inches in the radius of the circle defined by the horizontal circleness, and the vertically low profile of the body measures about 1¼ inches.

In another aspect, the lifter for windshield wiper blade further comprises a second lifter for windshield wiper blade in accord with the explanation above. The two lifters together form a pair of lifters, each of the pair of lifters configured for supporting each of a pair of wiper arms in a spaced apart relationship to the windshield.

In another aspect, the second opposite end portion is provided with graphics.

In another aspect, the lifter for windshield wiper blade further comprises a lanyard attached at one end to an attachment mechanism. The lanyard is configured for wrapping around the wiper arm. The attachment mechanism is configured to attach the first end of the lanyard to the lanyard after the lanyard has been wrapped around the wiper arm.

In another aspect, the lifter for windshield wiper blade is used in combination with a container configured for storing the lifter. The container may be a tote bag. The tote bag may have a drawstring to close the opening of the tote bag to keep lifters received by the tote bag from falling out during storage or transport.

In another aspect, a lifter for windshield wiper blade comprises a body having first and second opposite end portions. The body is horizontally rectangular and has a vertically low profile. The first opposite end portion releasably contacts the windshield when the body portion is positioned between a wiper arm and a windshield. The second opposite end portion releasably supports the wiper arm in a spaced apart relationship to the windshield when the first opposite end portion contacts wiper arm and the windshield. The body has a water buoyance that is positive.

In another aspect, the horizontal rectangleness of the body is a square.

The lifter of this disclosure may be configured according to the teachings of this disclosure. The dimensions of the lifters of this disclosure are per the teachings of this disclosure with the specific dimensions being a matter of design choice within these teachings.

The lifter of this disclosure extends the life of wiper blades with a low profile and simple, easy to use, user friendly, cost effective, mechano-dynamically modeled, and economically friendly lifter for windshield wiper blade. The disclosed lifter is further aesthetically pleasing and enhances surface area for designer graphics and/or personalization. The lifter of this disclosure is biodegradable, ecologically friendly, easily transportable, and with a buoyancy of under 1 floats on water.

While the disclosure has been described in conjunction with specific embodiments, it is evident that numerous alternatives, modifications, and variations will be apparent to those skilled in the art within the spirit and scope of the disclosure described above.

I claim:

1. A lifter for windshield wiper blade comprising:
a body having first and second opposite end portions, the body being horizontally elongate and having a vertically low profile, the first and second end opposite portions being without any corners;
the first opposite end portion releasably contacting the windshield when the body portion is positioned between a wiper arm and a windshield;
the second opposite end portion releasably supporting the wiper arm in a spaced apart relationship to the windshield when the first opposite end portion contacts the windshield and the body portion is positioned between the wiper arm and the windshield;
the first and second end opposite portions being free from attachment to the wiper arm and windshield;
the body being supportively firm along the vertically low profile, the supportive firmness configured to support the wiper arm in a spaced apart relationship to the windshield when the first opposite end portion contacts the windshield and the body portion is positioned between the wiper arm and the windshield;
the body being vertically flexible along at least a portion of the second opposite end portion, the vertical flexibility configured to cushion the support of the wiper arm when the first opposite end portion contacts the windshield and the body portion is positioned between the wiper arm and the windshield; and
the body having a water buoyance that is positive.

2. The lifter for windshield wiper blade of claim 1 wherein the horizontal elongateness of the body measures about 4 inches in a lengthwise direction of the horizontal elongateness and about 3 inches in a widthwise direction of the horizontal elongateness, and the vertically low profile of the body measures about three inches.

3. The lifter for windshield wiper blade of claim 1 wherein the body comprises a biodegradeable material.

4. The lifter for windshield wiper blade of claim 1 further comprising a second lifter for windshield wiper blade according to claim 1, the two lifters together forming a pair of lifters, each of the pair of lifters configured for supporting each of a pair of wiper arms in a spaced apart relationship to the windshield.

5. The lifter for windshield wiper blade of claim 1 wherein the second opposite end portion is provided with graphics.

6. The lifter for windshield wiper blade of claim 5 wherein the graphics on the second opposite end portion are selected from the group consisting of silk screened graphics and thermal printed graphics.

7. The lifter for windshield wiper blade of claim 1, further comprising:
a lanyard attached at one end to an attachment mechanism, the lanyard being configured for wrapping around the wiper arm;
wherein the attachment mechanism is configured to attach the first end of the lanyard to the lanyard after the lanyard has been wrapped around the wiper arm.

8. The lifter for windshield wiper blade of claim 4, further comprising:
a first lanyard attached at a first end to a first and at a second end to a second of the two lifters together forming the pair of lifters;
a second lanyard having a sliding mechanism at a first end and an attachment mechanism at a second end;
wherein the sliding mechanism of the second lanyard is configured to slide along the first lanyard and the second lanyard being configured for wrapping around the wiper arm; and
wherein the attachment mechanism is configured to attach the first end of the second lanyard to a part if the second lanyard after the second lanyard has been wrapped around the wiper arm.

9. The lifter for windshield wiper blade of claim 1 further comprising an attachment panel attached to the second opposite end portion, wherein the graphics on the second opposite end portion are applied to the attachment panel.

10. The lifter for windshield wiper blade of claim 1 in combination with a container configured for storing the windshield blade.

11. The lifter for windshield wiper blade of claim 10 wherein the container configured for storing the windshield wiper blade is a tote bag having a draw string.

12. The lifter for windshield wiper blade of claim 1 wherein the vehicle is a vehicle selected from the group consisting of motor vehicles, including cars, trucks, buses, motorcycles including mopeds and scooters, railed vehicles, including trains and trams, watercraft including ships and boats, amphibious vehicles including screw-propelled vehicle, hovercraft, aircraft including airplanes and helicopters, spacecraft, and wagons, bicycles, and carts including manual push or pull carts and mobile carts, including animal drawn carts and golf carts.

13. A lifter for windshield wiper blade comprising:
a body having first and second opposite end portions, the body being horizontally circular and having a vertically low profile, the first and second end opposite portions being without any corners;
the first opposite end portion releasably contacting the windshield when the body portion is positioned between a wiper arm and a windshield;
the second opposite end portion releasably supporting the wiper arm in a spaced apart relationship to the windshield when the first opposite end portion contacts the windshield and the body portion is positioned between the wiper arm and the windshield;
the first and second end opposite portions being free from attachment to the wiper arm and windshield;
the body being supportively firm along the vertically low profile, the supportive firmness configured to support the wiper arm in a spaced apart relationship to the windshield when the first opposite end portion contacts the windshield and the body portion is positioned between the wiper arm and the windshield;
the body being vertically flexible along at least a portion of the second opposite end portion, the vertical flexibility configured to cushion the support of the wiper arm when the first opposite end portion contacts the windshield and the body portion is positioned between the wiper arm and the windshield; and
the body having a water buoyance that is positive.

14. The lifter for windshield wiper blade of claim 13 wherein the horizontal circleness of the body measures about ½ inches in the radius of the circle defined by the horizontal circleness, and the vertically low profile of the body measures about 1 inch.

15. The lifter for windshield wiper blade of claim 13 wherein the horizontal circleness of the body measures about ¾ inches in the radius of the circle defined by the horizontal circleness, and the vertically low profile of the body measures about 1¼ inches.

16. The lifter for windshield wiper blade of claim 13 further comprising a second lifter for windshield wiper blade according to claim 13, the two lifters together forming a pair of lifters, each of the pair of lifters configured for supporting each of a pair of wiper arms in a spaced apart relationship to the windshield.

17. The lifter for windshield wiper blade of claim 13 wherein the second opposite end portion is provided with graphics.

18. The lifter for windshield wiper blade of claim 13, further comprising:
a lanyard attached at one end to an attachment mechanism, the lanyard being configured for wrapping around the wiper arm;
wherein the attachment mechanism is configured to attach the first end of the lanyard to the lanyard after the lanyard has been wrapped around the wiper arm.

19. The lifter for windshield wiper blade of claim 13 in combination with a container configured for storing the windshield blade; wherein the container configured for storing the windshield wiper blade is a tote bag with a draw string.

20. A lifter for windshield wiper blade comprising:
a body having first and second opposite end portions, the body being horizontally rectangular and having a vertically low profile;
the first opposite end portion releasably contacting the windshield when the body portion is positioned between a wiper arm and a windshield;
the second opposite end portion releasably supporting the wiper arm in a spaced apart relationship to the windshield when the first opposite end portion contacts the windshield and the body portion is positioned between the wiper arm and the windshield;
the first and second end opposite portions being free from attachment to the wiper arm and windshield;
the body being supportively firm along the vertically low profile, the supportive firmness configured to support the wiper arm in a spaced apart relationship to the windshield when the first opposite end portion contacts the windshield and the body portion is positioned between the wiper arm and the windshield;
the body being vertically flexible along at least a portion of the second opposite end portion, the vertical flexibility configured to cushion the support of the wiper arm when the first opposite end portion contacts the windshield and the body portion is positioned between the wiper arm and the windshield; and
the body having a water buoyance that is positive.
